(19) United States
(12) Patent Application Publication
(10) Pub. No.: US 2013/0336730 A1
(43) Pub. Date: Dec. 19, 2013

(54) AGGREGATE PROCESSING SYSTEM

(71) Applicant: BADER RADI YASSER ALENIZI, OMARIA (KW)

(72) Inventor: BADER RADI YASSER ALENIZI, OMARIA (KW)

(21) Appl. No.: 13/523,674

(22) Filed: Jun. 14, 2012

(51) Int. Cl. B65G 67/60; B65G 53/40; B65G 53/34; B65G 53/00

(52) U.S. Cl. 406/108

(57) ABSTRACT

The aggregate processing system is a substantially closed onshore system that provides significant improvement in economy by substantially eliminating the spread of dust and dirt and/or the partial filling of the berth with sediment during the offloading of aggregate materials from a bulk cargo ship. The system includes one or more extractors that draw the bulk aggregate material from the hold(s) of the ship by entraining the aggregate in a stream of water and air. The aggregate is automatically cleaned during this step, and passes to a separating hopper where the sand and water settle out and the clean gravel is transferred to surface transport. The sand and water pass to a settling tank, where the sand is recovered for use and the water is recycled for continued use.

### BACKGROUND OF THE INVENTION

1. Field of the Invention

The present invention relates generally to handling systems for raw materials used in the construction industry, and particularly to an aggregate processing system for simultaneously cleaning and transferring gravel and stone aggregate from a cargo ship to onshore processing and transport facilities.

2. Description of the Related Art

Aggregates comprising gravel, sand, stone, and similar materials are used throughout the world as ingredients in various construction materials, such as concrete, asphalt paving, and the like. Any given project may require many tons of such material. Hundreds of such projects may be underway at any given time. Virtually all such projects require that the completed structure meet certain standards of quality, which demand that the aggregates and other materials used be clean and free of undesirable foreign matter. Accordingly, there is high demand for large quantities of clean, high quality aggregate material.

Aggregates are mined from deposits of gravel and sand in numerous locations throughout the world. Such deposits are seldom located convenient to the construction site where they are needed, and thus require transportation from the mining site to the construction site. Moreover, the aggregate material nearly universally contains a great deal of foreign matter (dirt, vegetation, etc.) when it is mined, which must be removed from the aggregate in order to provide the high quality required for most construction projects. The aggregate must be further separated according to particle size and material, i.e., sand and gravel. While these two materials are commonly used together in the making of concrete and other poured and cast construction materials, the quality of the completed mix requires that the aggregate be mixed in specific ratios to one another. Thus, a loose undetermined mix of sand, gravel, and other materials is not suitable for use in the manufacture of most cast and poured construction materials.

In accordance with the above needs, various apparatus and systems have been developed in the past for mining, cleaning, separating, and transporting aggregate materials. These various systems and apparatus generally handle only one, or at best two, of the required steps in the process of recovering the aggregate materials from the mining site to delivering the processed aggregate to the construction site. Moreover, many such systems and apparatus cannot provide aggregate processing on the large scale needed for rapidly handling multiple tons of such material, as is the case when offloading bulk aggregate material from a bulk cargo ship. In such cases, it is important that the material be offloaded as rapidly as possible, in order to minimize the down time for the ship.

Aggregates are conventionally offloaded from the ship by means of the shipboard handling apparatus of the ship. This conventional offloading procedure is not concerned with the fallout of extraneous materials, e.g., dust, dirt, etc., from the operation. Accordingly, the buildup of dust and dirt in the port, and even the surrounding environs outside the port proper, is a chronic problem requiring effort and expense for cleanup. Much of the residual sand and dirt from such an open offloading operation ends up in the water where the cargo ship is berthed for the operation. It will be seen that this results in the partial filling of the berth with sediment after some period of time, thus necessitating the periodic dredging of the berth at some expense.

Thus, an aggregate processing system solving the aforementioned problems is desired.

### SUMMARY OF THE INVENTION

The aggregate processing system is a substantially closed system that precludes the substantial escape of dust, dirt, and extraneous matter during the process of offloading aggregate material from a cargo ship. The apparatus of the system is onshore, with the exception of the units temporarily and removably inserted into the hold(s) of the ship for withdrawing the aggregate material therefrom.

The aggregate processing system includes one or more hydropneumatic units that are inserted into the hold(s) of the aggregate cargo ship to withdraw the aggregate from the hold(s). These devices are powered by large volumes of air and water from an onshore air compressor and tank and an onshore water tank and pump system. The stream of air and water entrains the aggregate material in the stream to draw the material from the hold(s). This forms a slurry of aggregate gravel, sand, and other materials with the water and air. The slurry is then ducted from the ship to an onshore separation hopper through a closed tube(s). The large amount of water used to form the slurry automatically washes the aggregate simultaneously with the offloading operation.

The onshore separation hopper is a passive device having an internal screen that allows the sand and smaller particles to pass therethrough, along with the water. Air is vented from the system at this point. The washed gravel aggregate remains atop the screen, where it is passed to ground transportation vehicles (e.g., dump trucks, railroad hopper cars, etc.).

The water and residual material that has passed through the screen of the separation hopper is then ducted to a settling tank, where the heavier material settles out of the water passively due to gravity. The clean sand is captured in the bottom of the settling tank for use in the manufacture of concrete or other building materials. The relatively clean water is pumped back to the water tank for reuse in mixing with air for the further entrainment and removal of aggregate from the ship.

This closed system results in greater economy due to the constant recycling of the water used in the system, as well as the recovery of sand and other materials from the gravel aggregate. These recovered materials, particularly sand, have economic value. Moreover, the capture of sand and other materials obviates the previous problems of sand and dust residue in the port and surrounding areas, as well as obviating the need and associated expense of periodically dredging the dockside berths where aggregate cargo ships berth to offload their materials.

These and other features of the present invention will become readily apparent upon further review of the following specification and drawings.

### BRIEF DESCRIPTION OF THE DRAWINGS

FIG. 1 is a schematic diagram of a first embodiment of an aggregate processing system according to the present invention, illustrating various features thereof.

FIG. 2 is a schematic diagram of a second embodiment of an aggregate processing system according to the present invention, illustrating further features thereof.

Similar reference characters denote corresponding features consistently throughout the attached drawings.

### DETAILED DESCRIPTION OF THE PREFERRED EMBODIMENTS

The aggregate processing system is adapted for the largely automated, large scale handling of bulk aggregates, such as gravel, from ship to shore. The system includes a series of steps for offloading such materials from the bulk cargo ship, cleaning the aggregate, separating the aggregate into at least two sizes or grades, and delivering the aggregate material to ground transportation for delivery. The water used in the offloading and cleaning steps is recycled for economy.

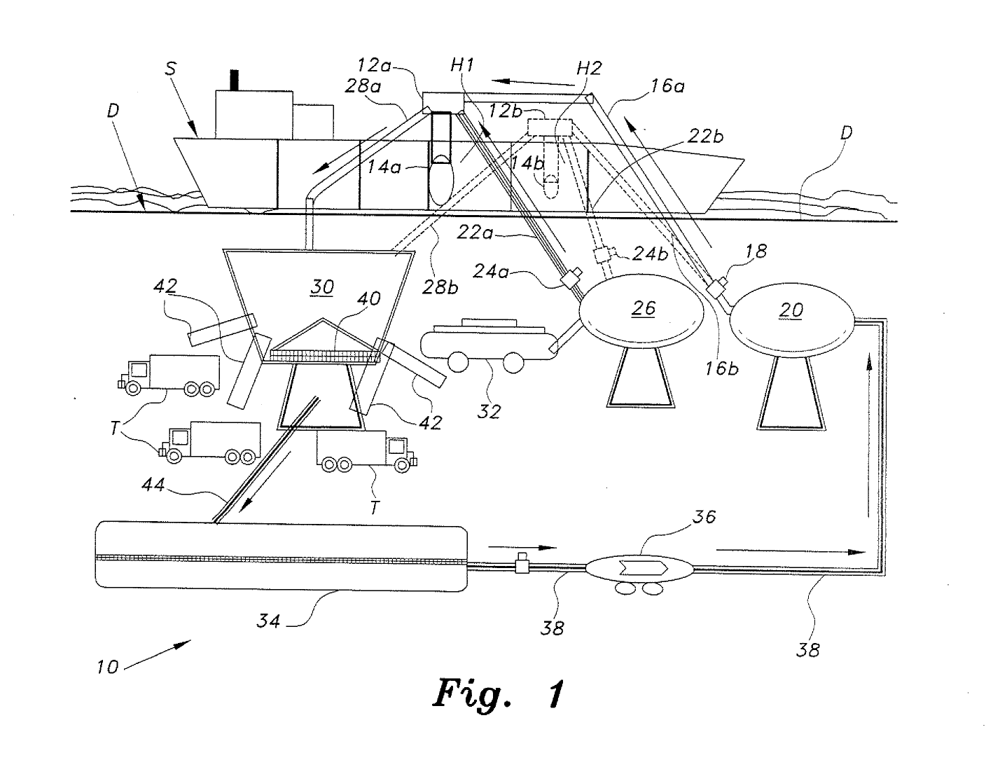

FIG. 1 of the drawings provides a schematic view of a first embodiment of the aggregate processing system 10. The system 10 is permanently installed as a fixed, stationary onshore installation on a dock D or the like, where it may be operated for the removal, cleaning, grading, and transfer of aggregate from a ship S to ground transport units T (trucks, as shown, or alternatively, rail cars).

Initially, one or more hydropneumatic aggregate ejectors 12a, 12b, along with their aggregate suction bits 14a and 14b, are positioned to extend into the hold(s) H1, H2 of the ship S once the ship has been docked. The assemblies, comprising the ejectors 12a and 12b and their suction bits 14a and 14b, operate by entraining the aggregate material in jets of high volume, high velocity air and water to form a slurry of aggregate and water, which is then ejected upward from the hold of the vessel to an onshore hopper for further processing. Corresponding high volume water delivery ducts or lines 16a, 16b are extended from the valve 18 of a high volume water supply tank 20 permanently installed onshore on the dock D.

Corresponding high volume air delivery ducts or lines 22a, 22b are extended from the respective valves 24a and 24b (a single valve may be provided having both air delivery lines 22a and 22b extending therefrom, as in the two water lines 16a and 16b) of a permanently installed high volume compressed air tank 26 on the dock D. Aggregate slurry transfer ducts or lines 28a and 28b are extended from the corresponding aggregate ejectors 12a and 12b to a permanently installed onshore aggregate passive separation hopper 30 on the dock D. The various water, air, and aggregate ducts 16a, 16b, 22a, 22b, 28a, and 28b are laterally closed tubular structures to preclude the escape of water, air, and/or aggregate therefrom during operations. These components 12a through 16b, 22a, 22b, 28a, and 28b are stored on the dock D with the other components of the system 10 when not in use.

Air is supplied to the compressed air tank 26 by a large, high volume air compressor 32. Air used in the system is not recycled, but is drawn in by the air compressor 32 and passed through the system via the air tank 26 and the closed air supply duct or line 22a (and 22b, if a second aggregate ejector and suction bit assembly are used) to the assembly or assemblies, and thence out with the aggregate slurry through the closed aggregate slurry transfer duct or line 28a (and 28b, in the case of a second ejector and suction bit assembly) to the hopper 30.

However, the water used in the system is preferably recycled, for economy. The water is initially collected in a sand and water separation tank 34 and drawn from that tank by a high volume pump 36 installed in a water return line or duct 38 that extends to the water tank 20. The water then flows through the closed water delivery line or duct 16a (and 16b, if a second ejector and suction bit assembly is used) to the aggregate ejector 12a (and optionally 12b) and its suction bit 14a (and optionally 14b) to entrain the gravel aggregate and other matter in the hold and wash it outward through the slurry transfer duct or line 28a (and optionally 28b) to the aggregate separation hopper 30.

The hopper 30 is a passive unit, i.e., it contains no powered machinery to separate the aggregate into different sizes or grades of material. Rather, the hopper 30 includes a separator screen 40 therein that allows the water and smaller particles of sand and the like to flow therethrough, while retaining larger gravel and stones thereabove. It will be seen that two or more progressively smaller mesh screens or separators 40 may be installed within the hopper 30 to grade the aggregate slurry into a number of different sizes. The graded aggregate, having been cleaned as a result of the water used to extract the aggregate from the ship S, then travels outward from the hopper 30 to waiting ground transportation T via one or more delivery chutes 42.

The water (and fine sand, as noted above) passes through the screen(s) or separator(s) 40, and exits the hopper 30 through a closed sand and water return line or duct 44 that extends from the hopper 30 back to the sand and water separation tank 34. The tank 34 is also a passive separation device. Sand settles to the bottom of the tank 34 due to gravity, where it may be removed at the end of the aggregate offloading operation for drying and use. The relatively clean water in the upper portion of the tank 34 is again drawn from the tank 34 through the closed water return line or duet 38 by the pump 36 and recycled through the system, as described above.

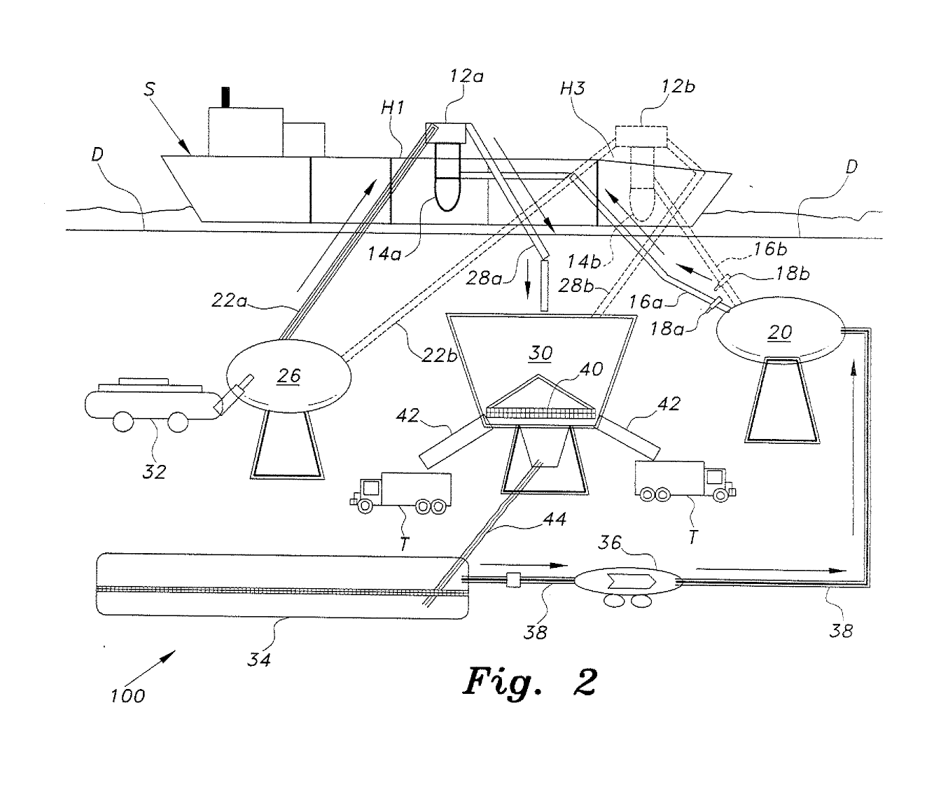

The aggregate processing system 100 illustrated schematically in FIG. 2 is very similar to the system 10 of FIG. 1. While the relative positions of many of the components are different in FIG. 2 in comparison to FIG. 1, the two systems 10 and 100 differ essentially only in the positioning of the water delivery duct or line 16a (and optionally 16b, when two ejectors 12a, 12b and suction bits 14a, 14b are used). In FIG. 2, the water supply or delivery duct or line 16a extends from the high volume water tank 20 to the top of the aggregate suction bit 14a, rather than to the ejector 12a, as in FIG. 1. The optional second ejector and suction bit assembly 12b, 14b in the hold H3 of the ship S also has its water delivery duct 16b connected to the top of the suction bit 14b in FIG. 2. Each of the water delivery ducts 16a, 16b includes its own valve 18a, 18b, although the two lines or ducts may branch from a single connector and valve 18, as in FIG. 1, if so desired.

The remaining components illustrated schematically in FIG. 2 are equivalent to those correspondingly numbered components shown in FIG. 1, but it will be seen that the relative locations of the high volume air tank 26, the compressor 32, and the passive separation hopper 30 have been reversed in FIG. 2 relative to their positions in FIG. 1. However, the system 100 of FIG. 2 operates essentially identically to the system 10 of FIG. 1. Relatively clean water flows from the sand and water separation tank 34 to the water tank 20 via the pump 36 and water return line or duet 38. The water is then delivered to the upper portion(s) of the aggregate suction bit(s) 14a (and 14b) by closed duct(s) 16a (and 16b). Air is provide by the compressor 32 to the compressed air tank 26, from which it is delivered to the ejector(s) 12a (and 12b) by closed air supply or delivery duct(s) 22a (and 22b). The aggregate slurry, comprising aggregate materials pumped from the hold(s) H1 (and H3) of the ship S and mixed with water and air, as described above, is pumped to the aggregate passive separation hopper 30 by the slurry transfer duct(s) 28a (and 28b). The washed and cleaned gravel aggregate is delivered from the hopper 30 to waiting transports T by the delivery chutes 42. Water and finer sand and the like falls through the screen(s) or separator(s) 40 to pass to the sand and water separator tank 34, where the sand and fine particles settle out to the bottom of the tank. The relatively clean water is then drawn from the tank 34 by the pump 36 to be recycled through the system.

The closed ducts and lines used throughout the system, along with the water used, essentially eliminate the spread of dust and dirt resulting from other open systems. The water used in the system is recycled, thus greatly reducing expense, and is also used to wash the aggregate material, thus increasing its commercial value and eliminating unwanted finer contaminants from the washed gravel and stone. Moreover, the finer sand particles that are removed from the gravel have some commercial value. The system serves to recover such materials, rather than flushing them overboard from the ship where they contaminate the dockside berth and require periodic dredging. Accordingly, the present aggregate processing system provides numerous efficiencies in operation that are not achieved by earlier systems used in the large scale offloading and processing of aggregate materials.

It is to be understood that the present invention is not limited to the embodiments described above, but encompasses any and all embodiments within the scope of the following claims.

1. An aggregate processing system, comprising:
at least one hydropneumatic ejector and aggregate suction bit assembly, each of the at least one assembly being adapted for removable placement in the hold of a bulk cargo ship;
a source of high volume air communicating pneumatically with each of the at least one assembly;
a source of high volume water communicating hydraulically with each of the at least one assembly;
an aggregate passive separation hopper communicating hydropneumatically with each of the at least one assembly; and
a sand and water separation tank communicating with the hopper;
wherein water separates sand from an aggregate material.

2. The aggregate processing system according to claim 1, wherein:
the source of high volume air is an onshore high volume compressed air tank;
an onshore high volume air compressor communicates pneumatically with the compressed air tank;
the source of high volume water is an onshore high volume water tank;
the aggregate passive separation hopper is a fixed, onshore installation; and
the sand and water separation tank is a fixed, onshore installation.

3. The aggregate processing system according to claim 1, further comprising:
a closed water supply duct extending between the source of high volume water and each of the at least one assembly;
a closed slurry transfer duct extending between each of the at least one assembly and the hopper;
a closed sand and water duct extending between the hopper and the sand and water separation tank;
a closed water return duct extending between the sand and water separation tank and the source of high volume water; and
a high volume water pump disposed in the closed water return duct, the pump being adapted for recycling water back to the source of high volume water.

4. The aggregate processing system according to claim 3, wherein the water supply duct is connected to the ejector of each of the at least one assembly.

5. The aggregate processing system according to claim 3, wherein the water supply duct is connected to the suction bit of each of the at least one assembly.

6. The aggregate processing system according to claim 1, wherein the sand and water separation tank is a passive gravity system.

7. The aggregate processing system according to claim 1, wherein:
the at least one hydropneumatic ejector and aggregate suction bit assembly comprises a plurality of assemblies; and
at least one aggregate delivery chute extends from the hopper.

8-14. (canceled)

15. An aggregate processing system, comprising:
at least one hydropneumatic ejector and aggregate suction bit assembly, each of the at least one assembly being adapted for removable placement in the hold of a bulk cargo ship;
a source of high volume air communicating pneumatically with each of the at least one assembly;
a source of high volume water communicating hydraulically with each of the at least one assembly;
a closed water supply duct extending between the source of high volume water and each of the at least one assembly;
an aggregate passive separation hopper communicating hydropneumatically with each of the at least one assembly;
a closed slurry transfer duct extending between each of the at least one assembly and the hopper;
a sand and water separation tank communicating with the hopper;
a closed sand and water duct extending between the hopper and the sand and water separation tank;
a closed water return duct extending between the sand and water separation tank and the source of high volume water; and
a high volume water pump disposed in the closed water return duct, the pump being adapted for recycling water back to the source of high volume water;
wherein water separates sand from an aggregate material.

16. The aggregate processing system according to claim 15, wherein the water supply duct is connected to the ejector of each of the at least one assembly.

17. The aggregate processing system according to claim 15, wherein the water supply duct is connected to the suction bit of each of the at least one assembly.

18. The aggregate processing system according to claim 15, wherein:
the source of high volume air is an onshore high volume compressed air tank;
an onshore high volume air compressor communicates pneumatically with the compressed air tank;
the source of high volume water is an onshore high volume water tank; and
the aggregate passive separation hopper is a fixed, onshore installation.

19. The aggregate processing system according to claim 15, wherein the sand and water separation tank is a passive gravity system.
